(19) United States
(12) Patent Application Publication
(10) Pub. No.: US 2009/0216707 A1
(43) Pub. Date: Aug. 27, 2009

(54) File resource usage information in metadata of a file

(75) Inventors: Susann M. Keohane, Austin, TX (US); Gerald F. McBrearty, Austin, TX (US); Shawn P. Mullen, Buda, TX (US); Jessica C. Murillo, Round Rock, TX (US); Johnny M. Shieh, Austin, TX (US)

Correspondence Address: IBM CORP. (WIP);c/o WALDER INTELLECTUAL PROPERTY LAW, P.C., 17330 PRESTON ROAD, SUITE 100B, DALLAS, TX, 75252, US

(73) Assignee: International Business Machines Corporation, Armonk, NY (US)

(21) Appl. No.: 12/037,195

(22) Filed: Feb. 26, 2008

(51) Int. Cl. G06F 17/30

(52) U.S. Cl. 707/1; 707/E17.001

(57) ABSTRACT

Resource utilization information for accessing a file is stored in metadata associated with the file. In response to a command to access the file, the resource utilization information is compared to pre-established warning criteria to determine if the resource utilization for accessing the file meets the criteria for generating a warning. Based on the results of the comparison, a warning message may be output, prior to accessing the file, if results of the comparison indicate that one or more warning criteria are met. The warning message may provide a provide a prompt for a user to determine if he/she still wishes to access the file and if so, the file is accessed; otherwise the operation for accessing the file is terminated prior to the file being accessed.

### BACKGROUND OF THE INVENTION

1. Field of the Invention

The present application relates generally to an improved data processing system and method. More specifically, the present application is directed to a system and method for storing file resource usage information in metadata of a file.

2. Background of the Invention

With the increased size of applications and files, the amount of resources necessary to run these large applications on such large files has dramatically increased in recent years. Many times a user may select to open a file or load a file for opening/execution that causes an immediate performance degradation on the computing system the user is using. For example, a user may have embedded a word processing document with multimedia content, e.g., a Java applet or QuickTime video file or the like, which will greatly increase the amount of resources that will be consumed when the word processing document is opened or loaded for opening. However, before attempting to open or load the file, the user is not aware that such content is embedded in the word processing document file and thus, does not know that the opening or loading of the file will result in a degradation of the performance of the computing system as it attempts to provide the resources needed by the word processing document file. As a result, the user only perceives a seemingly unexplainable slow down of the computing system in response to accessing the file.

### BRIEF SUMMARY OF THE INVENTION

In one illustrative embodiment, a method, in a data processing system, for outputting a warning of resource utilization meeting warning criteria. The method may comprise, in response to a command to access a file, analyzing metadata associated with the file to identify resource utilization information in the metadata indicating an resource utilization required to access the file. The method may further comprise comparing the resource utilization required to access the file to pre-established warning conditions in a configuration file. Moreover, the method may comprise outputting, prior to accessing the file, a warning message in response to results of the comparison indicating that one or more of the pre-established warning conditions are met.

In other illustrative embodiments, a computer program product comprising a computer useable or readable medium having a computer readable program is provided. The computer readable program, when executed on a computing device, causes the computing device to perform various ones, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones, and combinations of, the operations outlined above with regard to the method illustrative embodiment.

These and other features and advantages of the present invention will be described in, or will become apparent to those of ordinary skill in the art in view of, the following detailed description of the exemplary embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an exemplary representation of an exemplary distributed data processing system in which aspects of the illustrative embodiments may be implemented;

FIG. 2 is a block diagram of an exemplary data processing device in which aspects of the illustrative embodiments may be implemented;

FIG. 3 is a block diagram illustrating a file and associated metadata having resource utilization information in accordance with one illustrative embodiment;

FIG. 4 is a block diagram of an exemplary resource manager in accordance with one illustrative embodiment;

FIG. 5 is a diagram illustrating a warning message that may be output in accordance with one illustrative embodiment;

FIG. 6 is a flowchart outlining an operation for generating resource utilization metadata and associating it with a file in accordance with one illustrative embodiment; and

FIG. 7 is a flowchart outlining an operation for presenting a warning based on a comparison of file resource utilization metadata with a predetermined threshold in accordance with one illustrative embodiment.

### DETAILED DESCRIPTION OF THE INVENTION

The illustrative embodiments provide a mechanism for storing resource usage information in metadata associated with files to be used in providing warnings in the event that a predetermined threshold of resource usage is exceeded. The illustrative embodiments allow a user or other entity to be informed when the accessing of a file may cause a performance degradation of the data processing system due to excessive resource utilization by the file. This warning may provide an option to discontinue an access operation for accessing the file and/or an option to continue the access operation despite the possible performance degradation.

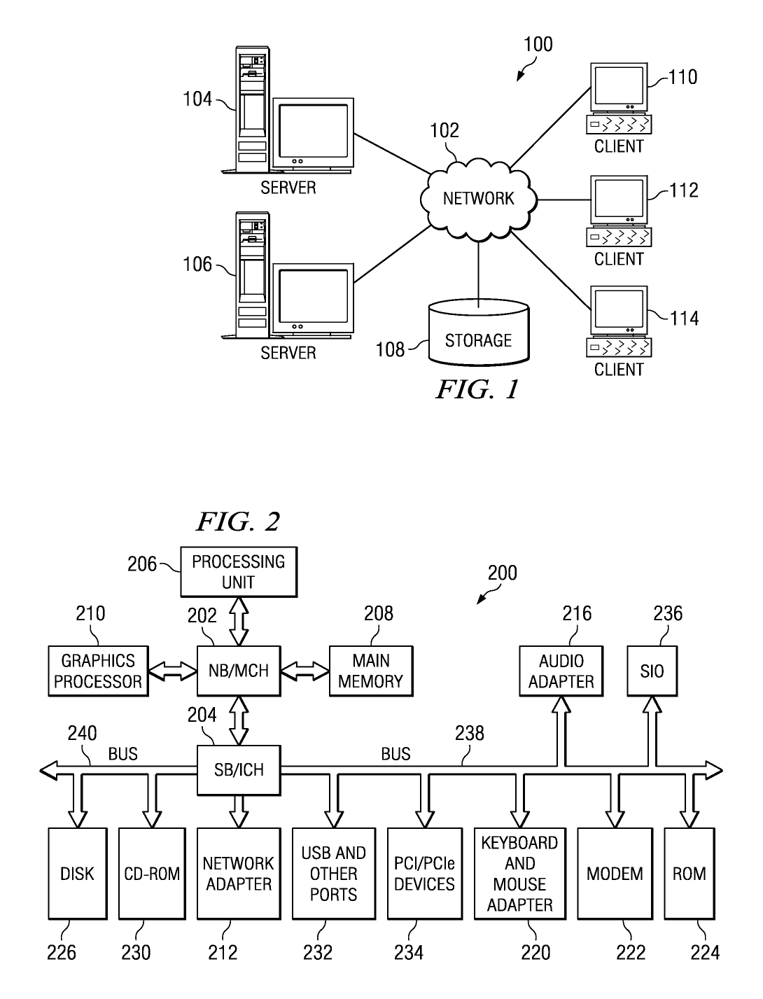

Thus, the illustrative embodiments may be utilized in many different types of data processing environments including a distributed data processing environment, a single data processing device, or the like. In order to provide a context for the description of the specific elements and functionality of the illustrative embodiments, FIGS. 1 and 2 are provided hereafter as exemplary environments in which exemplary aspects of the illustrative embodiments may be implemented. While the description following FIGS. 1 and 2 will focus primarily on a single data processing device implementation with warnings being provided to a user, this is only exemplary and is not intended to state or imply any limitation with regard to the features of the present invention. To the contrary, the illustrative embodiments are intended to include distributed data processing environments and embodiments in which warnings are automatically provided to any entity, whether it be a human being, an application, another data processing device, or the like, with responses to the warnings being provide either manually by a human or automatically by an application, data processing device, or the like.

With reference now to the figures and in particular with reference to FIGS. 1-2, exemplary diagrams of data processing environments are provided in which illustrative embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of an exemplary distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an exemplary data processing system is shown in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ System p® computer system, running the Advanced Interactive Executive (AIX®) operating system or the LINUX® operating system (eServer, System p, and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

As mentioned above, many times a user may select to open a file or load a file for opening/execution that, unknown to the user prior to the selection of the file, causes an immediate performance degradation on the computing system the user is using. For example, a particular file may utilize X amount of resources, unbeknownst to the user, while a running application utilizes Y amount of resources. While the running application does not itself negatively impact the performance of the computing system, the combination of the resource requirements of the running application and the file that is going to be potentially opened may cause the computing system to perform at less than a desired level. In other words, before attempting to open or load the file, the user is not aware that the file, or content that is embedded in the file, requires a significant enough amount of resources such that if those resources are allocated to the file, the result is a degradation of the performance of the computing system. The user only perceives a seemingly unexplainable slow down of the computing system in response to accessing the file.

With the illustrative embodiments, in an effort to address the problem of unknowingly opening a file that requires an amount of resources that would result in a degradation of performance of the computing system, a mechanism is provided for notifying a user, an application, or the like, when the amount of resources required by a file that is to be opened or loaded, in combination with a current resource usage level, would exceed a threshold. This notification mechanism uses resource utilization information stored in metadata associated with the file. In response to a command to access the file, the resource utilization information, in combination with current resource utilization information for the computing system, is compared to a threshold to determine if the resource utilization for accessing the file would cause resource utilization for the computing system to exceed the threshold. Based on the results of the comparison, a warning message may be output, prior to accessing the file, if results of the comparison indicate that the amount of resources required to access the file exceeds the predetermined threshold. The warning message may provide a prompt for a user to determine if he/she still wishes to access the file and if so, the file may be accessed. If the user determines not to continue with accessing the file, such access of the file is terminated prior to the file being opened or loaded. Alternatively, such determinations may be made automatically when the originator of a request to access the file is an application operating without direct user interaction.

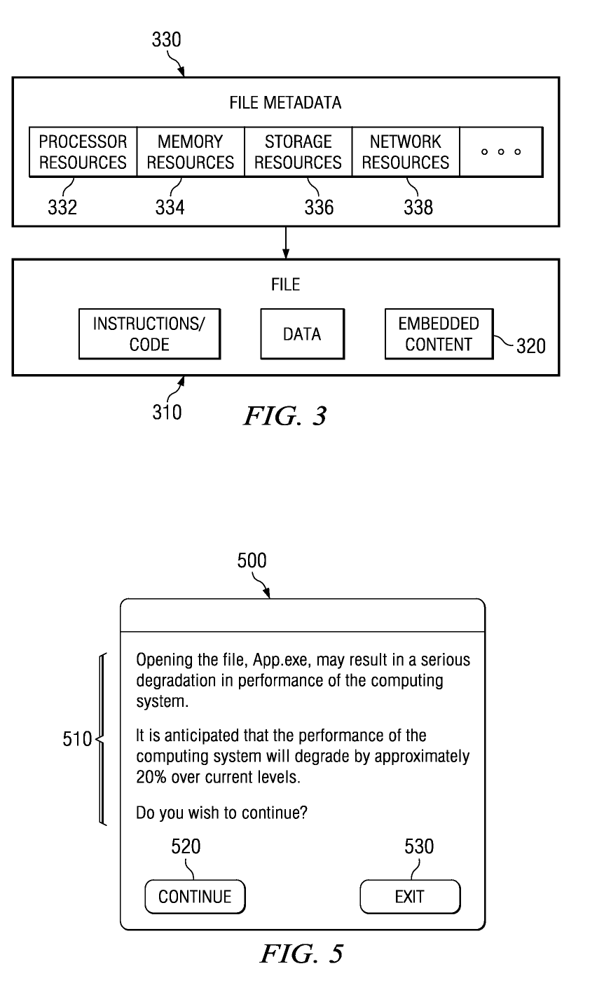

FIG. 3 is a block diagram illustrating a file and associated metadata having resource utilization information in accordance with one illustrative embodiment. As shown in FIG. 3, a file 310 is provided which may comprise only data, code, executable instructions, or any combination of code, data, etc. The file 310 may be opened by another application, loaded and/or executed by an operating system or other application, or the like. The file 310 may further include embedded content 320 which may take many different forms including data structures, multi-media content, applets, binary code, embedded files within a file, or the like.

As shown in FIG. 3, the file 310 has associated metadata 330 which stores, among other metadata information that may be generally stored in accordance with known systems, data representative of the amount of resources that are predicted to be needed when opening, loading, or executing the associated file 310. This metadata 330 may include fields 332-338 for storing information regarding various resources needed to access the associated file 310. For example, field 332 stores data representative of the amount of processor resources needed to access the file 310, field 334 stores data representative of the amount of system memory resources needed to access the file 310, field 336 stores data representative of the amount of storage system resources needed to access the file 310, and field 338 stores data representative of the amount of network bandwidth resources needed to access the file 310. Other resource usage data may be stored in similar fields within the file metadata 330 including, for example, how many file pointers are sued by the file 310, how many interrupts are encountered during execution of the file, how many third party plug-in applications are referenced, what minimum screen resolution is required, how much disk space is used by the program during execution, and the like.

The data in fields 332-338 may be generated based on a previous monitoring of the opening, loading, execution, of the like, of the file 310. This previous monitoring may be performed by a resource manager in response to a creation and first execution of the file 310, for example. Moreover, the data in fields 332-338 may be generated by a resource manager in response to the opening, loading, execution, or the like, of a file that does not have associated resource usage metadata. Furthermore, the data fields 332-338 may be updated through monitoring of resource utilization by the resource manager every time that the file 310 is opened, loaded, executed, etc. or in response to a user requesting that the resource usage metadata be updated based on a prompt output to the user in response to the file 310 being loaded, opened, executed, etc.

The resource manager may monitor the resource usage associated with the file 310 as the file 310 is loaded, opened, executed, etc. to thereby generate resource usage metrics. The resource usage monitoring may be performed with regard to a particular predefined set of one or more types of resources and associated metrics, such as how much memory the file 310 uses, how many processor cycles are used by the loading, opening, and/or execution of the file 310, how many file pointers are used by the file 310, etc. When the file 310 is exited, i.e. the execution is discontinued, the file 310 is unloaded, the file 310 is closed, or the like, the resource usage metrics may be analyzed to calculate resource utilization data values for storage in the metadata 330 associated with the file 310. The analysis may involve various calculations including average resource usage metric calculations, peak resource usage metric calculations, or any other statistical calculation that would provide an indication of an expected resource usage for subsequent loading, opening, execution, etc. of the file 310.

In one illustrative embodiment, a weighted calculation, based on the various types of resource metrics gathered, may be performed to generate a single value indicative of the resource utilization of the file 310. For example, a first weight may be associated with processor cycle utilization, a second weight may be associated with system memory utilization metrics, a third weight may be associated with network bandwidth utilization metrics, etc. Various functions using such weightings may be used to generate a single value indicative of resource utilization of the file 310. This single value may be stored in the metadata 330 for use by the mechanisms of the illustrative embodiments. Alternatively, separate values for each, or a subset, of the resource usage metrics may be calculated and stored in the metadata 330.

Thus, the illustrative embodiments provide a mechanism for monitoring resource usage or utilization during the opening, loading, execution, or the like, of a file 310 and the calculation of resource usage data based on the gathered resource usage metrics. The resource usage data may then be stored in metadata 330 associated with the file 310. This resource usage data is then used when an access attempt is made targeting the file 310. Essentially, the resource usage data is used to compare to one or more thresholds, conditions, or the like, that are pre-established for defining situations in which a potential degradation of performance of a computing system is likely.

A user may specify parameters in a user account configuration file associated with the resource manager that identifies one or more conditions under which the user, or applications, are to be informed that the opening, loading, execution, or the like, of the file 310 may result in a degradation in performance of a computing system. Such conditions may include, for example, a parameter identifying that if the file 310 to be opened will consume more than M Megabytes of memory during its operation, then a warning should be displayed or returned to an application prior to loading, opening, executing, or the like, the file. Other conditions may include determining if the file to be opened will start a Java engine, determining if the file to be opened will start downloading from a third party resource, e.g., a website such as a multimedia content server, anti-virus update server, etc., determining if a number of processor cycles required to execute the file will exceed a predetermined threshold, or the like.

When a file 310 is opened, loaded, executed, etc., by a user or an application, the resource manager, in association with the file system of the computing device, examines the file's associated metadata 330 to determine if the metadata 330 contains resource usage metadata, such as in fields 332-338. If the metadata 330 contains resource usage metadata, the resource manager may retrieve the user's account configuration file and compares the resource usage metadata with the pre-established conditions set forth in the user's account configuration file. If any one of the conditions set forth in the user's account configuration file are met by the resource usage metadata, then a warning message is output to the user or the application.

The warning message may take many different forms depending upon the particular implementation. In one illustrative embodiment, the warning message may be an electronic message sent as data to an application, the operating system (OS), or other software requesting access to the file indicating that the accessing of the file may result in a degradation of performance of the computing system. The message may identify a relative amount of potential degradation based on an amount over which the resource utilization information exceeds any thresholds. In response to this electronic message, the application, OS, or other software may automatically determine whether to continue the accessing of the file or to discontinue the accessing of the file. Such a decision may be based on the relative amount of potential degradation of system performance.

Alternatively, the message may be output to a user via a display device, audio output device, and/or the like. The message may indicate that a potential degradation in performance will be experienced if the access of the file is permitted to occur. The message may further identify a relative amount of performance degradation should the accessing of the file continue. Moreover, the message may have user selectable options, such as provided by graphical user interface virtual buttons or the like, for selecting whether to continue with the accessing of the file or to discontinue accessing the file. Based on a user selection of one of these virtual buttons, the OS of the computing device, in conjunction with the file system and the resource manager, may either continue the accessing of the file or discontinue the accessing of the file.

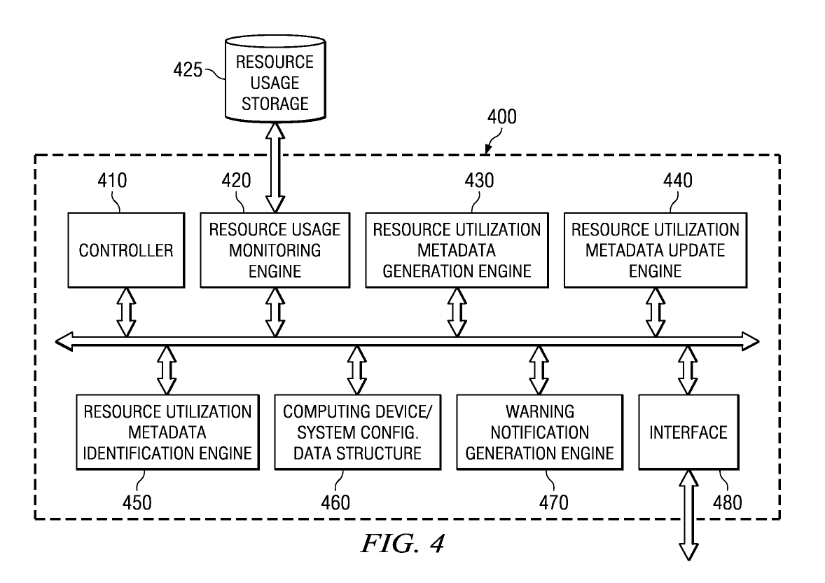

FIG. 4 is a block diagram of an exemplary resource manager in accordance with one illustrative embodiment. The elements shown in FIG. 4 may be implemented in software, hardware, or any combination of software and hardware. In one illustrative embodiment, the elements of FIG. 4 are implemented as software instructions executed on one or more processing devices.

As shown in FIG. 4, the resource manager 400 comprises a controller 410, a resource usage monitoring engine 420, a resource utilization metadata generation engine 430, a resource utilization metadata update engine 440, a resource utilization metadata identification engine 450, a computing device configuration data structure 460, a warning notification generation engine 470, and an interface 480. The controller 410 controls the overall operation of the resource manager 400 as well as orchestrates the operation of the other elements 420-480. Operations not specifically attributed to the individual elements 420-480 are considered to be performed by the controller 410.

The resource usage monitoring engine 420 is responsible for monitoring the resource usage of a file while the file is opened, loaded, executed, etc. Such monitoring may be initiated in response to the resource utilization metadata identification engine 440 indicating that a file to be opened, loaded, executed, etc., does not have associated resource usage metadata. Alternatively, the resource usage monitoring engine 420 may monitor resource usage by a file in response to the resource utilization metadata update engine 440 indicating that the resource usage metadata associated with a file should be updated. In response to initiating the resource usage monitoring by the resource usage monitoring engine 420, the resource usage monitoring engine 420 may collect resource usage metrics for a plurality of different resources including processor resources, memory resources, network connection resources, application resources, and the like. These metrics may be collected by the resource usage monitoring engine 420 and stored in an associated resource usage storage 425 for use in calculating resource usage metadata values for storage in resource usage metadata associated with the file being monitored.

The calculation of such resource utilization metadata based on the gathered metrics may be performed by the resource utilization metadata generation engine 430. As noted above, the resource utilization metadata generation engine 430 may perform a number of different types of statistical calculations for generating the resource utilization metadata including calculating peak resource utilization, average resource utilization, mean utilization, etc. The resulting resource utilization metadata is stored in a metadata data structure linked to the file being monitored. The linkage of the metadata data structure with the file may be performed by integrating the metadata in the file itself or otherwise providing a pointer or other link to the metadata data structure from the file such that the linkage causes the metadata data structure to be loaded when the file is loaded.

As mentioned above, the resource utilization metadata update engine 440 may initiate resource utilization monitoring in response to a determination that an update to resource utilization metadata associated with a file to be opened, loaded, executed, or the like, is to be performed. The determination of whether to update resource utilization metadata may be performed by the resource utilization metadata update engine 440 based on any of a number of different parameters. For example, if the resource utilization metadata is older than a predetermined time period from the current time, then a resource utilization metadata update operation may be required. Similarly, if the file has been opened, loaded, executed, etc. more than a predetermined number of times since a last resource utilization metadata update, then such an update may be required. Still other criteria may be established, for example, in a configuration file (not shown) associated with the resource manager 400 against which current conditions may be evaluated to determine if an update of the resource utilization or usage metadata is warranted.

The resource utilization metadata identification engine 450 operates to extract the resource utilization metadata from a metadata data structure associated with a file that is to be accessed, i.e. opened, loaded, executed, etc. The resource utilization metadata extracted by the resource utilization metadata identification engine 450 may be provided to the warning notification generation engine 470. This resource utilization metadata may be combined with current resource usage information for the computing system. This current resource usage information may be obtained from other monitoring applications on the computing system, from the resource usage monitoring engine 420 which may monitor current resource usage in the computing system as well resource usage of a file for purposes of generating resource utilization or usage metadata for the file, or the like.

The warning notification generation engine 470 may compare the resource utilization metadata alone, or a combination of the resource utilization metadata with current resource utilization information for the system to thereby generate an expected resource utilization of the computing system if the file is permitted to be accessed, against one or more thresholds. Moreover, other characteristics of the resource utilization metadata may be compared against conditions indicative of a potential degradation in computing system performance. For example, whether the file will begin downloading from a third party source, whether the file requires a Java engine, etc. The criteria against which the resource utilization metadata alone, or in combination with the current resource usage of the computing system, is compared may be provided in the computing device configuration data structure 460. These criteria may be defined by a user, such as via the interface 480, for example.

Based on results of the comparison, the warning notification generation engine 470 may determine whether or not a warning notification message is to be output. If a warning notification message is to be output, the warning notification generation engine 470 may generate the message, including an indication of how much above the one or more thresholds the potential resource utilization of the file exceeds the one or more thresholds, which other criteria were met by the resource utilization metadata, and the like. Moreover, the warning notification message may include user interface virtual buttons or the like for selecting whether to continue access of the file or to discontinue access of the file. The generated warning messages may be output via the interface 480 and responses may be received via the interface 480. The interface 480 may further provide the communication mechanism through which the monitoring of resource usage is actually performed.

FIG. 5 is a diagram illustrating a warning message that may be output in accordance with one illustrative embodiment. As can be seen in FIG. 5, in one illustrative embodiment, the warning message may be a warning message 500 that is output to a user for the user to select whether to continue accessing a file or not. Such a warning message may include text 510 indicating that that a potential degradation in performance will occur if the file is accessed and what resource utilization metadata and the conditions met or exceeded by the resource utilization metadata that has led to this determination. In addition, the warning message 500 may include user interface items 520 and 530 for selecting whether or not to access the file or not. Based on the user's selection of the user interface item 520, the operating system, file system, and resource manager operate in concert to continue the access operation for accessing the file. Based on a user's selection of the user interface item 530, the operating system, file system, and resource manager operate in concert to abort or discontinue the access operation for accessing the file. An abort or termination message may be displayed indicating that the file access was terminated or aborted early.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The illustrative embodiments are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

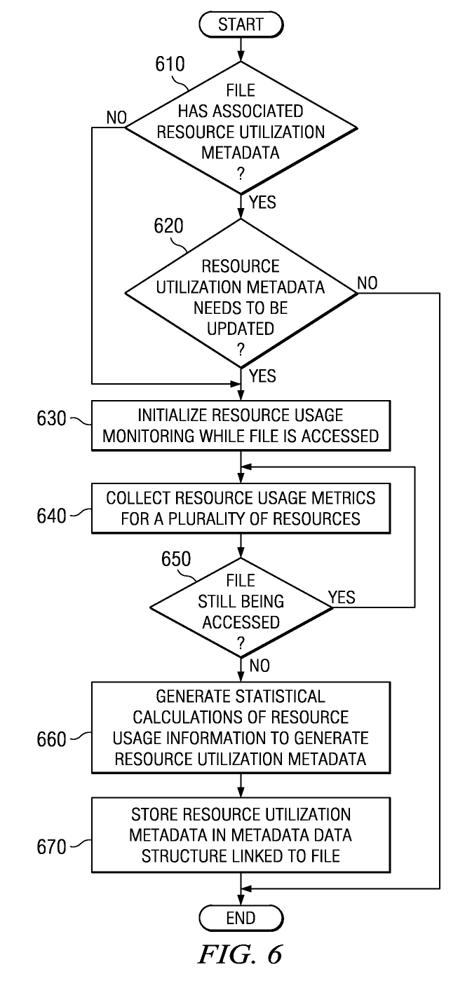

FIG. 6 is a flowchart outlining an operation for generating resource utilization metadata and associating it with a file in accordance with one illustrative embodiment. The operation outlined in FIG. 6 may be performed, for example, by a resource manager executing in a computing system, for example.

As shown in FIG. 6, the operation starts with a determination as to whether a file to be accessed has associated resource utilization metadata (step 610). If the file has associated resource utilization metadata, a determination is made as to whether the resource utilization metadata needs to be updated (step 620). If the resource utilization metadata does not need to be updated, then the operation terminates. If either the file to be accessed does not have associated resource utilization metadata or if the resource utilization metadata needs to be updated, then resource usage monitoring is initialized while the file is being accessed (step 630). Resource usage metrics for a plurality of resources are collected (step 640) and a determination is made as to whether the file is no longer being accessed (step 650). If the file is still being accessed, the operation returns to step 640.

If the file is no longer being accessed, then statistical calculations of resource usage information are performed and other resource utilization information is collected to generate the resource utilization metadata (step 660). The resource utilization metadata is then stored in a metadata data structure that is linked to the file (step 670). The operation then terminates.

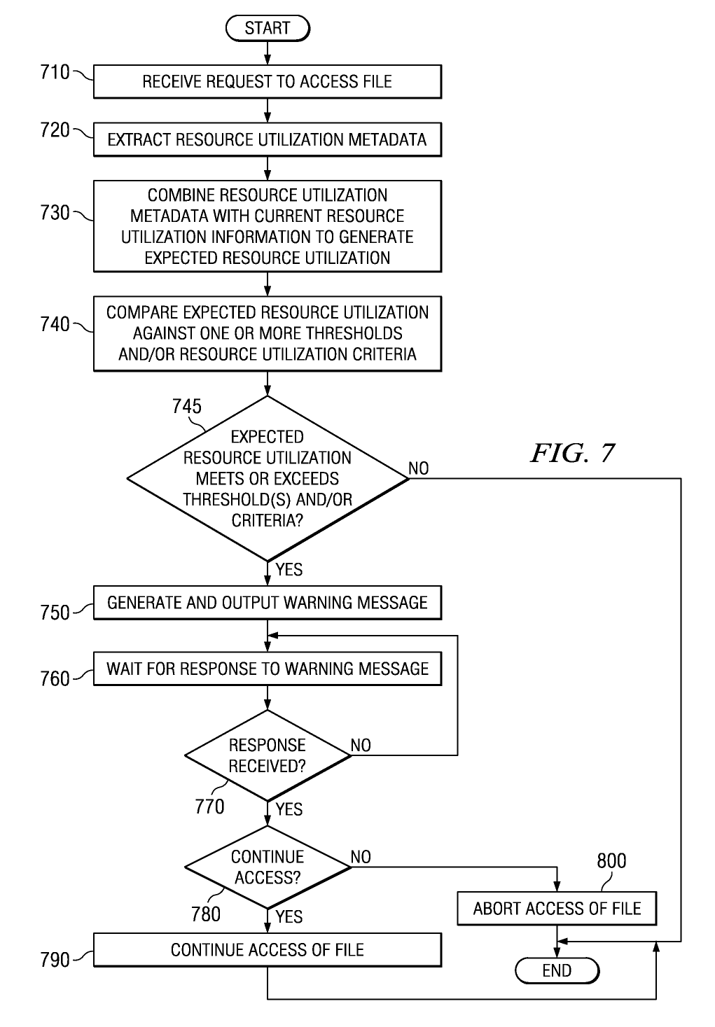

FIG. 7 is a flowchart outlining an operation for presenting a warning based on a comparison of file resource utilization metadata with a predetermined threshold in accordance with one illustrative embodiment. Again, the operation outlined in FIG. 7 may be performed by a resource manager executing in a computing system, for example. The operation in FIG. 7 may be performed in parallel with the operation outlined in FIG. 6, for example.

As shown in FIG. 7, the operation starts with receiving a request to access a file (step 710). Resource utilization metadata associated with the file is extracted if any (step 720). The resource utilization metadata may then be combined with current resource utilization information for the computing system (step 730). The resulting resource utilization information represents the predicted or expected resource utilization if the file is permitted to be accessed. This expected resource utilization is compared against one or more thresholds and/or resource utilization criteria (step 740). A determination is made as to whether the expected resource utilization meets or exceeds the one or more thresholds and/or resource utilization criteria (step 745). If the expected resource utilization meets or exceeds the one or more thresholds and/or resource utilization criteria, then a warning message is generated and output (step 750). If the expected resource utilization does not meet or exceed the one or more thresholds and/or resource utilization criteria, then a warning message is not generated and output and the operation terminates.

After outputting the warning message, the operation waits for a response to the warning message (step 760). A determination is made as to whether a response is received (step 770). If a response has not been received, and assuming that the warning message has not timed out, then the operation returns to step 760. If a response is received, a determination is made as to whether the response indicates to continue the access operation for the file (step 780). If so, then the file is accessed (step 790). If the response indicates to abort the accessing of the file, or if the warning message times out, then accessing of the file is aborted (step 800). The operation then terminates.

As noted above, it should be appreciated that the illustrative embodiments may take the form of an entirely hardware embodiment, an entirely software embodiment or an embodiment containing both hardware and software elements. In one exemplary embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for outputting a warning of resource utilization exceeding a predetermined threshold, comprising:
in response to a command to access a file, analyzing metadata associated with the file to identify resource utilization information in the metadata indicating a resource utilization required to access the file;
comparing the resource utilization required to access the file to one or more pre-established warning conditions; and
outputting, prior to accessing the file, a warning message in response to results of the comparison indicating that one or more of the pre-established warning conditions are met.

2. The method of claim 1, further comprising:
combining the resource utilization required to access the file with current resource utilization of the data processing system to generate a combined resource utilization requirement, wherein comparing the resource utilization required to access the file to pre-established warning conditions comprises comparing the combined resource utilization requirement to the one or more pre-established warning conditions.

3. The method of claim 1, further comprising:
receiving a response to the warning message, wherein the response indicates whether accessing the file is to be aborted or continued;
aborting accessing the file, prior to actual accessing of the file, if the received response indicates that the accessing of the file should be aborted; and
accessing the file if the received response indicates that the accessing of the file should be continued.

4. The method of claim 1, wherein the warning message comprises a user prompt for selecting whether to abort accessing of the file or not.

5. The method of claim 1, wherein the metadata comprises one or more fields that each store data representative of an amount of a particular resource required in order to access the file associated with the metadata.

6. The method of claim 5, wherein the one or more fields comprise at least one of a field for specifying an amount of processor resources needed to access the file, a field for specifying an amount of system memory resources needed to access the file, a field for specifying an amount of storage system resources needed to access the file, or a field for specifying an amount of network bandwidth resources needed to access the file.

7. The method of claim 5, wherein the one or more fields comprise at least one of a field for specifying how many file pointers are used by the file, a field for specifying how many interrupts are encountered during execution of the file, a field for specifying how many third party plug-in applications are referenced by the file, a field for specifying a minimum screen resolution required to access the file, or a field for specifying how much disk space is used by the file during execution.

8. The method of claim 1, further comprising generating the metadata by:
monitoring resource utilization of the file during a previous accessing of the file;
collecting resource utilization metric data during the previous accessing of the file; and
generating the metadata based on the collected resource utilization metric data.

9. The method of claim 8, wherein generating the metadata further comprises:
performing one or more statistical calculations based on the collected resource utilization metric data to generate the metadata, wherein the one or more statistical calculations comprises at least one of an average resource usage metric calculation or a peak resource usage metric calculation.

10. The method of claim 9, wherein at least one of the one or more statistical calculations is a weighted statistical calculation, based on various types of resources for which the resource utilization metric data is collected, that generates a single value indicative of the resource utilization of the file.

11. A computer program product comprising a computer useable medium having a computer readable program stored thereon, wherein the computer readable program, when executed on a computing device, causes the computing device to:
analyze, in response to a command to access a file, metadata associated with the file to identify resource utilization information in the metadata indicating a resource utilization required to access the file;
compare the resource utilization required to access the file to one or more pre-established warning conditions; and
output, prior to accessing the file, a warning message in response to results of the comparison indicating that one or more of the pre-established warning conditions are met.

12. The computer program product of claim 11, wherein the computer readable program further causes the computing device to:
combine the resource utilization required to access the file with current resource utilization of the data processing system to generate a combined resource utilization requirement, and wherein the computer readable program causes the computing device to compare the resource utilization required to access the file to pre-established warning conditions by comparing the combined resource utilization requirement to the one or more pre-established warning conditions.

13. The computer program product of claim 11, wherein the computer readable program further causes the computing device to:
receive a response to the warning message, wherein the response indicates whether accessing the file is to be aborted or continued;
abort accessing the file, prior to actual accessing of the file, if the received response indicates that the accessing of the file should be aborted; and
access the file if the received response indicates that the accessing of the file should be continued.

14. The computer program product of claim 11, wherein the warning message comprises a user prompt for selecting whether to abort accessing of the file or not.

15. The computer program product of claim 11, wherein the metadata comprises one or more fields that each store data representative of an amount of a particular resource required in order to access the file associated with the metadata.

16. The computer program product of claim 15, wherein the one or more fields comprise at least one of a field for specifying an amount of processor resources needed to access the file, a field for specifying an amount of system memory resources needed to access the file, a field for specifying an amount of storage system resources needed to access the file, or a field for specifying an amount of network bandwidth resources needed to access the file.

17. The computer program product of claim 15, wherein the one or more fields comprise at least one of a field for specifying how many file pointers are used by the file, a field for specifying how many interrupts are encountered during execution of the file, a field for specifying how many third party plug-in applications are referenced by the file, a field for specifying a minimum screen resolution required to access the file, or a field for specifying how much disk space is used by the file during execution.

18. The computer program product of claim 11, wherein the computer readable program further causes the computing device to generate the metadata by:
monitoring resource utilization of the file during a previous accessing of the file;
collecting resource utilization metric data during the previous accessing of the file; and
generating the metadata based on the collected resource utilization metric data.

19. The computer program product of claim 18, wherein the computer readable program causes the computing device to generate the metadata further by:
performing one or more statistical calculations based on the collected resource utilization metric data to generate the metadata, wherein the one or more statistical calculations comprises at least one of an average resource usage metric calculation or a peak resource usage metric calculation.

20. The computer program product of claim 19, wherein at least one of the one or more statistical calculations is a weighted statistical calculation, based on various types of resources for which the resource utilization metric data is collected, that generates a single value indicative of the resource utilization of the file.

21. A data processing system, comprising:
a processor; and
a memory coupled to the processor, wherein the memory comprises instructions which, when executed by the processor, cause the processor to:
analyze, in response to a command to access a file, metadata associated with the file to identify resource utilization information in the metadata indicating a resource utilization required to access the file;
compare the resource utilization required to access the file to one or more pre-established warning conditions; and
output, prior to accessing the file, a warning message in response to results of the comparison indicating that one or more of the pre-established warning conditions are met.
